(19) United States
(12) Patent Application Publication
(10) Pub. No.: US 2014/0198388 A1
(43) Pub. Date: Jul. 17, 2014

(54) FABRY-PEROT DEVICE WITH A MOVABLE MIRROR

(71) Applicant: Gooch and Housego PLC, Ilminster (GB)

(72) Inventors: MURRAY KEITH REED, MENLO PARK, CA (US); RICHARD ADAM NEILY, WESTLAKE VILLAGE, CA (US); CHRISTOPHER N. PANNELL, ORLANDO, FL (US); DIETER HANS JUNDT, PALO ALTO, CA (US)

(73) Assignee: Gooch and Housego PLC, Ilminster (GB)

(21) Appl. No.: 14/153,839

(22) Filed: Jan. 13, 2014

Related U.S. Application Data
(60) Provisional application No. 61/751,315, filed on Jan. 11, 2013.

(51) Int. Cl. G02B 26/00

(52) U.S. Cl. CPC G02B 26/001
USPC 359/578

(57) ABSTRACT

A Fabry-Perot tunable filter (FPTF) includes a top mirror having a first surface for receiving light and a second surface opposite the first surface. A movable mirror having a front side is secured to the second surface of the top mirror and includes back side. The movable mirror includes an inner bend resistant portion, wherein the front side includes a flexible front side portion outside the inner bend resistant portion recessed relative to the inner bend resistant portion, and a front side outer bend resistant portion thicker than the flexible front side portion. The back side includes a flexible back side portion outside the inner bend resistant portion and a back side outer bend resistant portion thicker than the flexible back side portion. An actuator mechanically coupled to the back side of the movable mirror moves the inner bend resistant portion relative to the second surface of the top mirror.

### CROSS REFERENCE TO RELATED APPLICATIONS

This application claims the benefit of Provisional Application Ser. No. 61/751,315 entitled “FABRY-PEROT CAVITY DEVICES”, filed Jan. 11, 2013, which is herein incorporated by reference in its entirety.

### FIELD

Disclosed embodiments relate to Fabry-Perot cavity devices.

### BACKGROUND

The Fabry-Perot (FP) cavity or FP filter can be used to measure the spectral components of an optical signal. The most basic form of a FP filter is two partially reflecting mirror surfaces, placed so that the mirror surfaces are facing each other and arranged to be highly parallel to one another, at a distance commonly referred to as being “d” apart. The inner facing mirror surfaces (mirrors) are vacuum deposited or otherwise formed on substrates of a suitable optically transparent material for the wavelength range of interest, and are often in the form of identical discs or plates.

The transfer function as a function of wavelength (T(λ)) of a basic FP filter assuming incident on-axis rays of light is given by:

$$T ( λ ) = \frac{1 - {R}^{2}}{1 + {R}^{2} - 2 R cos ( 4 π d \text{/} λ )}$$

Where R is the reflectivity of the mirrors, d is the separation distance (or gap) of the mirrors, and λ is the wavelength of the light being processed. The peaks in transmission of the FP filter (passband wavelength) occur at the values of λ given by:

$${λ}_{n} = \frac{2 d}{n}$$

where n=1, 2, 3, . . . .

The transfer function of the FP filter repeats, with the biggest gap being between peaks in terms of wavelength occurring between λ₁ and λ₂, this being equal to one octave, i.e., λ₁=2λ₂. If the desired wavelength measurement range is restricted to the range λ₁ to λ₂ then the FP filter provides an unambiguous measurement (only one peak) within this range, which is one octave. This restriction in turn places a restriction on the allowed range of d, which is that d varies between λ₁/2 and λ₁. The gap (d) is far smaller than usually encountered in “classical” FP spectroscopy, and offers the possibility of constructing a simple tunable optical filter using few passive components.

The spacing and parallelism of the plates for FP filters is known to be important. Since as described above the wavelengths at which transmission occurs is determined by d, so that it is important to know what d is. In addition, parallelism of the mirrors is important for FP filters since any deviation from this condition will cause the FP filter's transmission peak to collapse, so that the device will not work correctly. In “classical” FP spectroscopy, piezoelectric actuators are often used coupled to one or both mirrors in order to be able to adjust the parallelism, and to allow wavelength scanning over a limited range by changing d. It is common to mount 3 actuators symmetrically around the periphery of the discs (at 120° with respect to one another) in order to allow full control of the tilt of one mirror surface relative to the other mirror surface.

The width of the transmission peaks is governed by the Finesse of the FP filter which in turn depends on the reflectivity R of the mirrors. It is known to use FP filters in series to extend the free spectral range and the resolution. For example, see J. E. Mack et al in an article entitled “The PEPSIOS Purely Interferometric High-Resolution Scanning Spectrometer. I. The Pilot Model”, Applied Optics, Vol. 2, Issue 9, pp. 873-885 (1963), the subject matter in Mack is hereby incorporated by reference into this application.

### SUMMARY

Disclosed embodiments include Fabry-Perot (FP) cavity devices including in one embodiment FP tunable filters (FPTFs) having a membrane “movable mirror” including both front side and back side flexible (membrane) portions and an inner (e.g., center) bend resistant thicker portion in the beam path, where the inner thicker portion in the beam path resists bending to preserve the finesse. Disclosed embodiments recognize having both front side and back side flexible portions allow a suitable actuator to provide essentially only linear movement of the inner bend resistant portion of the movable mirror in the direction of the light beam.

Another disclosed embodiment is a FP device including multiple FPTFs including some embodiments with different gaps and thus different free spectral ranges, where the respective gaps are configured to narrow the composite passband of the device while still retaining good out-of-band rejection. In one embodiment the FPTF includes built-in capacitive sensing elements by including electroded mirrors where one of the mirrors is an electrically floating mirror.

### BRIEF DESCRIPTION OF THE DRAWINGS

Reference will now be made to the accompanying drawings, which are not necessarily drawn to scale, wherein:

FIGS. 1A-E show depictions of an example FPTF and portions thereof, according to example embodiments.

FIGS. 2A and 2B depict electroded top and bottom mirrors of an example FP device providing a built-in capacitive sensor, according to an example embodiment.

FIGS. 2C and 2D depict electroded top and bottom mirrors for an example FP device providing a built-in capacitive sensor, while FIG. 2E provides the electrical equivalent circuit for the built-in capacitive sensor, according to another example embodiment.

FIG. 3 is a cross-sectional depiction of an example dual-cavity FP device including a first FPTF and a second FPTF positioned back-to-back and sharing a top mirror to provide tunable FP filters in series each having a disclosed movable mirror, according to an example embodiment.

FIGS. 4A-J show theoretical simulated transmission spectrum data for some disclosed dual-cavity FPTF devices including FIGS. 4A through 4E configured for the visible light range and FIGS. 4F-J configured for the infrared light range.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

A first disclosed embodiment comprises a FPTF having a flexible membrane mirror referred to herein as a “movable mirror” and a conventional non-movable mirror generally referred to herein as a top mirror. These mirrors together with a structure for moving or deforming the movable mirror define the tunable optical cavity of the FPTF device. The movable mirror includes an inner bend resistant portion in the path of the light beam, and a front side flexible portion and a back side flexible portion both outside the inner bend resistant portion. Because the front side and back side flexible portions are near both ends of the movable mirror and extend outward in two (2) directions from the inner bend resistant portion of the movable mirror, disclosed embodiments recognize that arrangement provides the advantage of constraining the inner bend resistant portion of the movable mirror to move essentially only in a highly one dimensional motion in the direction of the light beam (perpendicular to the mirror planes).

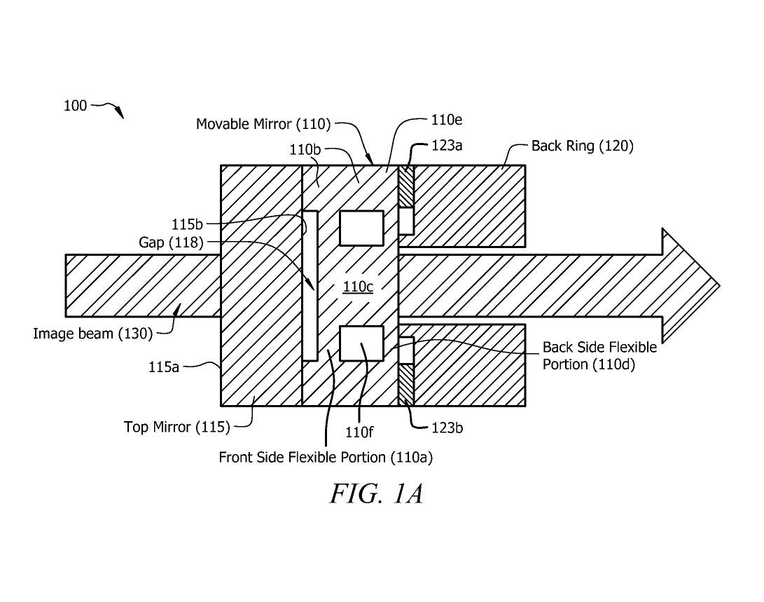

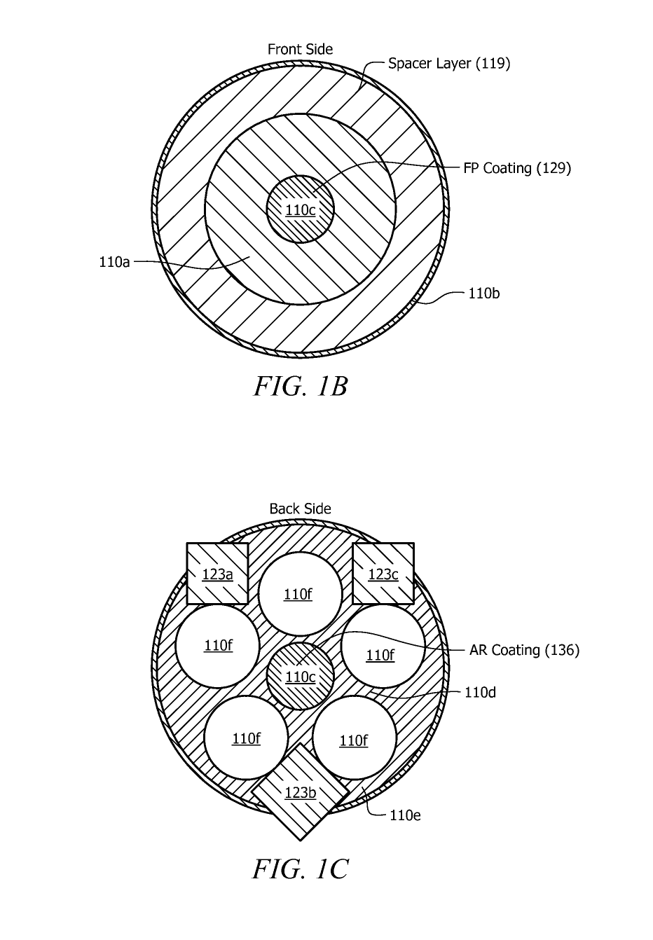

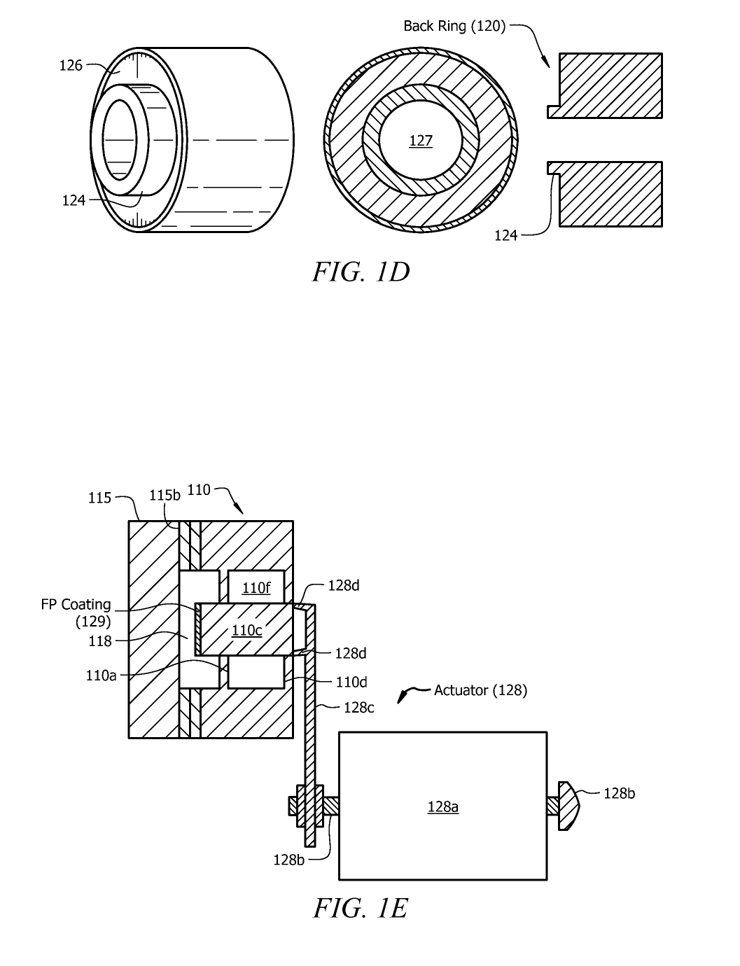

FIG. 1A is a cross-sectional depiction of an example FPTF 100 including a top mirror 115 having a first surface 115a for receiving a light beam shown as an image beam 130 and a second surface 115b opposite the first surface. Although not shown, the first surface 115a can include an AR coating and second surface 115b can include a FP coating. A movable mirror 110 includes an inner bend resistant portion 110c in a path of the image beam 130, and a front side flexible (membrane) portion 110a. Movable mirror 110 also includes a front side outer bend resistant portion 110b which is secured to (e.g., optically contacted and bonded to) the second surface 115b of the top mirror 115. Front side outer bend resistant portion 110b is shown thicker than both the flexible front side flexible portion 110a and the bend resistant portion 110c thus protruding relative to the front side flexible portion 110a and bend resistant portion 110c to provide the gap 118 shown. Movable mirror 110 also includes a thin back side flexible (membrane) portion 110d having several holes 110f and an outer back side portion 110e which is secured to a the piezoelectric (e.g., lead zirconium titanate (PZT)) elements 123a and 123b shown.

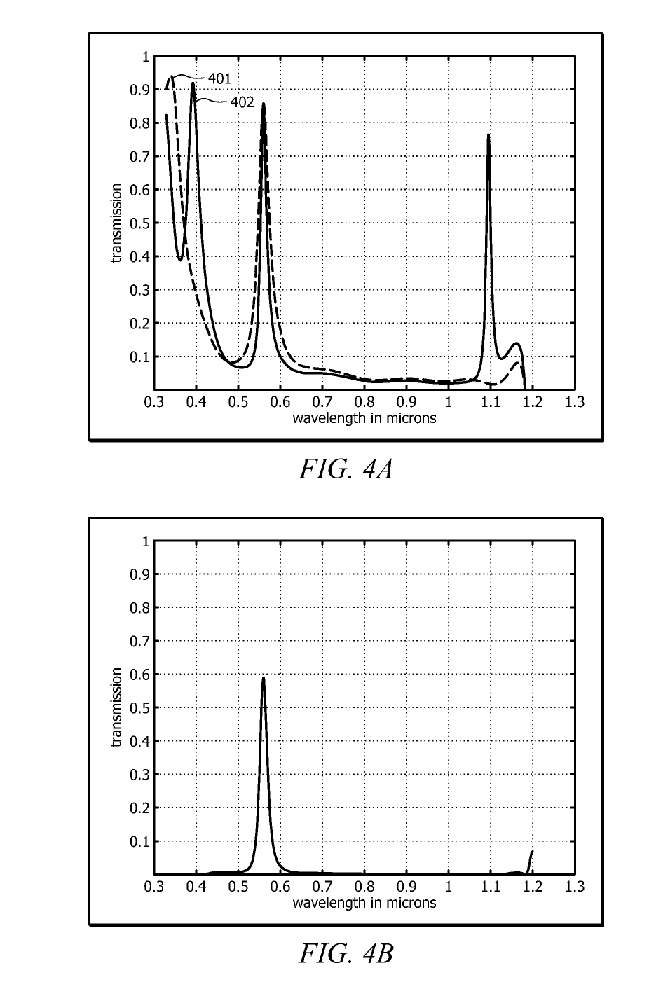

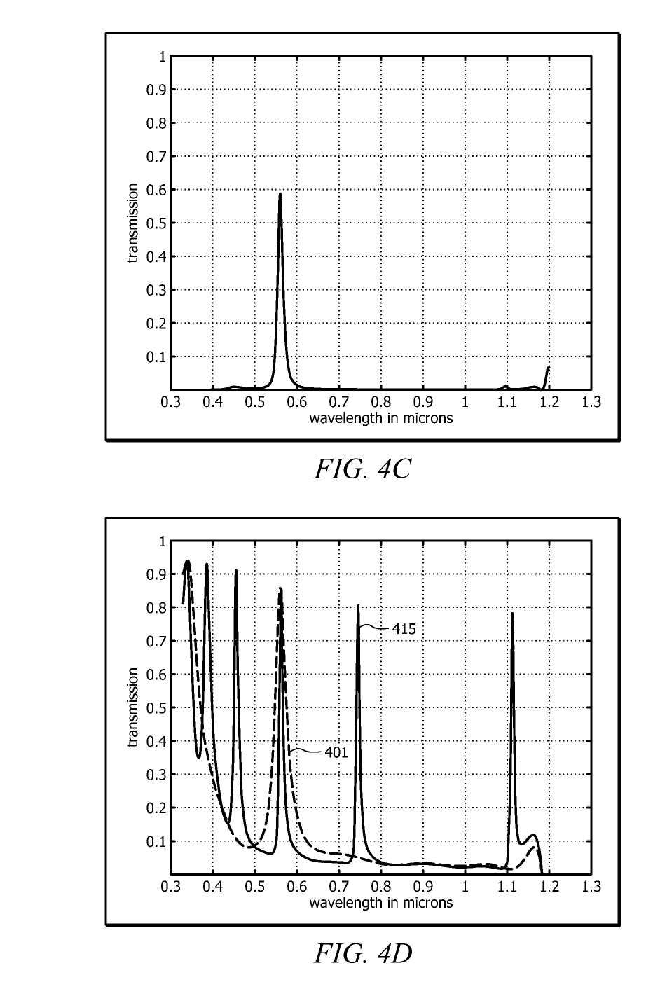

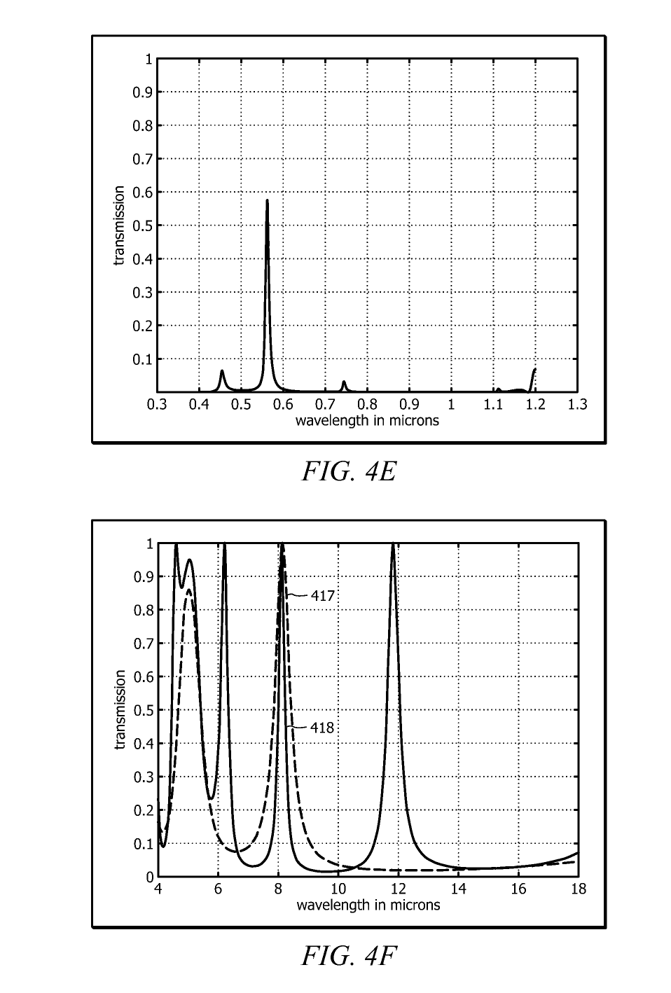

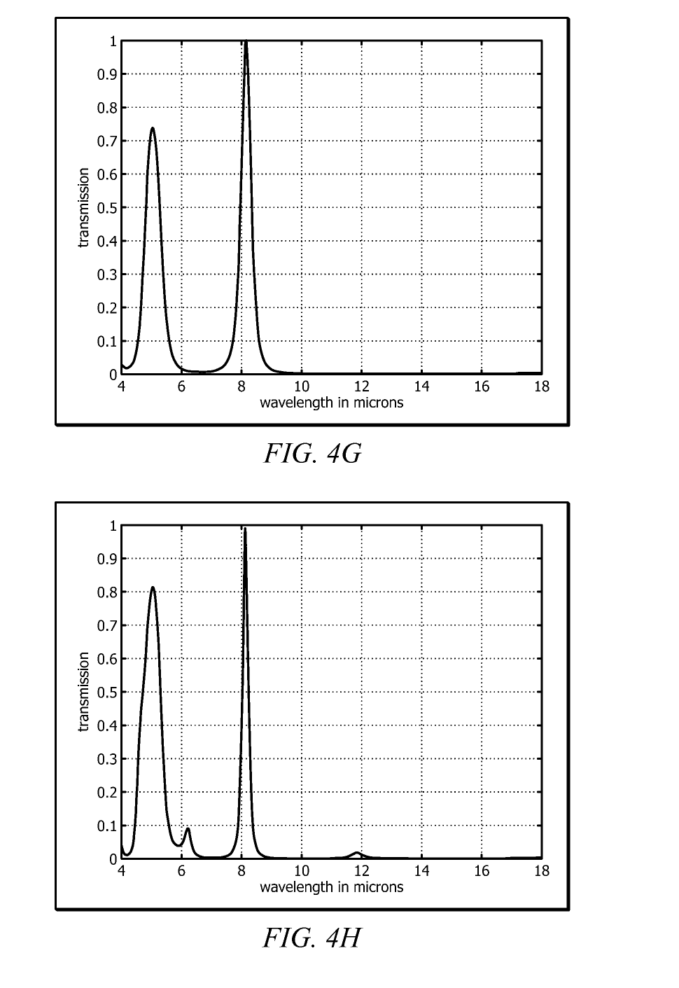

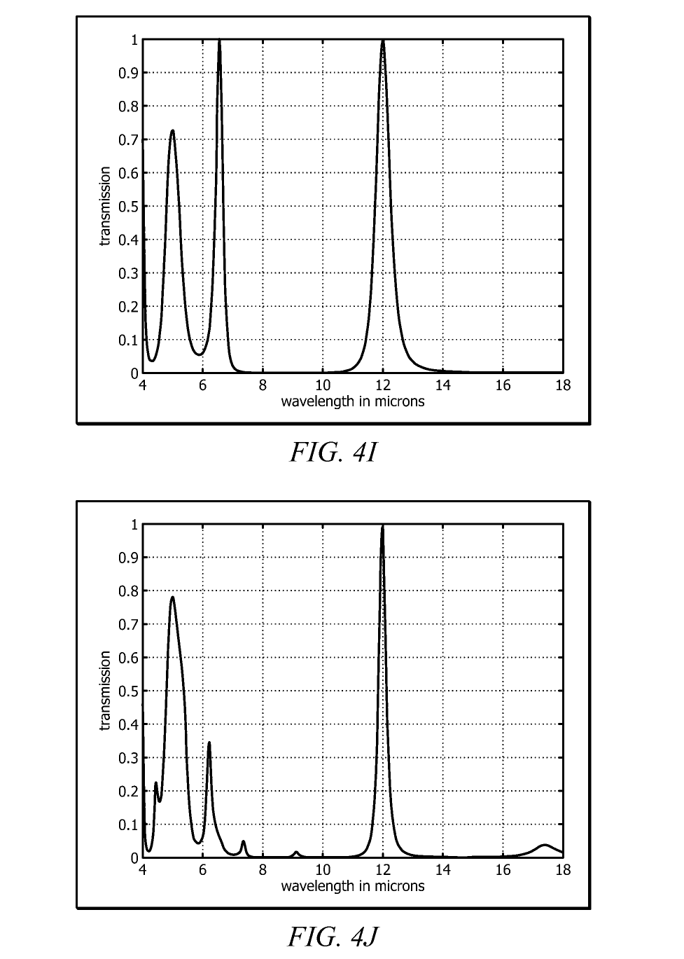

In one implementation, suitable for visible light applications, the top mirror 115, movable mirror 110 and back ring 120 are all made of fused silica. For infrared devices (wavelength>2200 nm with transmission spectrum data shown in FIGS. 4F through 4J), a material is chosen for the top mirror 115, movable mirror 110 and back ring 120 that is optically transparent in the infrared. Some examples of infrared transparent materials include calcium fluoride (CaF₂), zinc selenide (ZnSe), Si, Ge and a variety of chalcogenide glasses.

Regarding dimensions, for example, in one particular embodiment the front side flexible portion 110a is 0.027″ (685 μm) to 0.031″ (787 μm) thick, and the protrusion provided by the front side outer bend resistant portion 110b and bend resistant portion 110c extending beyond the front side flexible portion 110a is from 0.05″ (1270 μm) to 0.09″ (2286 μm) thick. Although bend resistant portion 110b can extend as shown in FIG. 1A beyond bend resistant portion 110c to provide the gap 118, as described below the gap 118 can be created by starting with a co-planar bend resistant portion 110b and bend resistant portion 110c and selectively adding a spacer layer 119 to the bend resistant portion 110b.

The structure and formation of the back side flexible portion 110d is somewhat more complex. One example way to form back side flexible portion 110d is to first drill from the backside of the movable mirror 110 a plurality of holes 110f. A suitable tool can them be inserted into the holes 110f to remove the material (e.g. fused silica) in between and below adjacent back side flexible portions 110d. Such a tool can be used to define the back side flexible portion 110d thickness. The stiffness of back side flexible portion 110d is largely governed by its thickness, which can be 0.032″ (812 μm) to 0.038″ (965 μm), and the length and minimum width of the outer back side portion 110e which functions as bridges between the holes 110f. A similar suitable tool can be used to form the backside of the front side flexible portion 110a.

FIG. 1B shows a face-on view of the front side of the movable mirror 110 and FIG. 1C a face-on view of the back side of the movable mirror 110. In the front side view of FIG. 1B, inner bend resistant portion 110c can be seen with the front side flexible portion 110a outside the inner bend resistant portion 110c recessed relative to the inner bend resistant portion 110c. The front side outer bend resistant portion 110b with the “spacer” layer 119 on top is thicker than the front side flexible portion 110a outside the front side flexible portion 110a. A FP coating 129 is shown on the front side of the movable mirror 110 on inner bend resistant portion 110c. In one particular embodiment, FP coating 129 comprises 30 nm to 40 nm of Ag (silver) with an overcoat of 20 nm to 25 nm of SiO₂ (silicon dioxide). The overcoat can help avoid environmental degradation (oxidation) of the Ag. The thickness of the Ag or other FP coating material is chosen to achieve a desired reflectivity. Typically, the reflectivity of the FP coating material is chosen to be above 90% for the wavelength range of interest. A higher reflectivity gives narrower transmission peaks and lower light throughput away from the peaks, i.e. better contrast. There are limits, however from mirror flatness and roughness considerations. The front side outer bend resistant portion 110b is shown as being a ring-shaped region.

As noted above, the front side outer bend resistant portion 110b shown in FIG. 1B includes a “spacer” layer 119 which protrudes relative to the inner bend resistant portion 110c. The spacer layer 119 is one way to implement the front side outer bend resistant portion 110b shown in FIG. 1A extending beyond the bend resistant portion 110c so that movable mirror 110 provides a nominal gap 118 between the inner bend resistant portion 110c and the second surface 115b of the top mirror 115. Spacer layer 119 can be the same material or a different material compared to the material used for the movable mirror 110. In one embodiment, the spacer layer material can be amorphous silicon dioxide, which would be nominally the same chemical composition as the movable mirror 110 in the case the movable mirror is formed from fused silica (fused silica is also silicon dioxide, but in crystalline form). Having the same chemical composition can aid in the assembly (optical contacting without any adhesive/glue). In this embodiment it is the spacer layer 119 which is bonded to the second surface 115b of the top mirror 115, while the inner bend resistant portion 110c being recessed relative to the spacer layer 119 remains unbonded and is thus free to move to allow FPTF 100 prove a tunable response.

The spacer layer 119 can also be deposited using thin film selective deposition techniques onto the perimeter area of the second surface 115b of the top mirror 115. In yet another implementation, the spacer layer 119 can be deposited onto both the front side of the outer bend resistant portion 110b of the movable mirror 110 as well as on the matching area on the second surface 115b of the top mirror 115. After bonding the two surfaces together, the spacer layer 119 will separate the second surface 115b of the top mirror 115 and outer bend resistant portion 110b by an amount equal to the total spacer thickness for both mirrors (115/110). Thin film deposition techniques are well suited to deposit a uniform spacer layer (over its area) with a selectable thickness of a few hundred to a few thousand nm. This method ensures that the mirror surfaces forming the FP cavity are essentially parallel within the required accuracy with no adjustment needed. The thickness for the spacer layer 119 is chosen to provide sufficient separation of the two FP mirror surfaces such that the device can be operated in push-only configuration for the wavelength range of interest. The spacer layer 119 thickness can be selected based on the region of the spectrum targeted by the application. Example regions of the spectrum that can be targeted include visible light (e.g., 400 nm to 750 nm), and the mid-infrared region of the spectrum (e.g. 3-12 microns).

Now referring to FIG. 1C, the back side of the movable mirror 110 is shown including flexible back side portion 110d outside the inner bend resistant portion 110c and an outer back side portion 110e thicker than the flexible back side portion 110d outside the flexible back side portion 110d. Several holes (e.g., circular holes) 110f are shown on the back side view of the movable mirror 110 arranged along a ring shaped region. Piezoelectric elements 123a, 123b and 123c are shown on the outer back side portion 110e. The center portion of the back side of movable mirror 110 corresponding to inner bend resistant portion 110c is shown including an anti-reflective (AR) coating 136.

The flexible portions 110a and 110d of the respective sides of the movable mirror 110 can be formed in a variety of ways. In one embodiment, as noted above, the front side flexible portion 110a is formed by selectively removing material from the front surface to form a recessed annular depression, and the flexible back side portion 110d can be formed by selectively removing internal material from the body of the movable mirror 110 via access provided by the holes 110f in the back side of the movable mirror 110. The result of this process is the formation of a thin annular membrane to provide front side flexible portion 110a on the front surface of the movable mirror 110 and a back side surface having another flexible back side portion 110d containing the holes 110f.

The movable mirror 110 can be a single piece (e.g., a single glass piece) or a composite multipart assembly of two (2) or more pieces of material (e.g., glass) glued or otherwise optically contacted together. Thus, instead of forming the back side (bottom surface) of the flexible back side portion 110d from a single plate as described above, the back side flexible back side portion 110d can be a thin plate of separate piece of material (e.g., glass) having the desired thickness for flexible back side portion 110d glued or otherwise optically contacted to the bottom surface of the movable mirror 110 which has a top surface flexible membrane analogous to the front side flexible portion 110a formed by selectively removing material from recessed annular depressions from the top side, and a back side surface flexible back side portion similarly formed by selectively removing material from recessed annular depressions from the back side surface. This embodiment avoids the need for holes 110f (for access) and machining to selectively remove internal material from the body of the movable mirror 110.

Top mirror 115 is essentially flat and can be about 1 inch in diameter in one particular embodiment with the first surface 115a receiving the image beam 130 including an anti-reflective (AR) coating, and a thin high reflectivity coating (e.g. 97% for the wavelength of interest) on the second surface 115b. The movable mirror 110 can be about 1 inch in diameter and in a typical embodiment having a thin high reflectivity coating (e.g. 97% for the wavelength of interest) on the cavity side and an anti-reflecting (AR) coating on the other side. In a typical embodiment, the inner bend resistant portion 110c and outer bend resistant portion 110b are 3 to 20 times thicker as compared to thin front side flexible portion 110a which as noted can be a thickness range from 0.027″ to 0.031″, but more generally can be from 0.017″ to 0.041″ thick. The thicker inner bend resistant portion 110c, such as 0.13″ to 0.25″ preserves the finesse of the FPTF 100 for processing the image beam, and can allow movement of the movable mirror 110 by a single actuator element.

The actuator is shown in FIGS. 1A and 1B as piezoelectric (e.g., lead zirconium titanate (PZT)) elements 123a, 123b and 123c (123(c) shown only in FIG. 1C) which along with electrodes (not shown) when biased provide electrically actuated control of the distance (d) of the gap 118 by displacement in the direction of the image beam 130. In operation, piezoelectric elements 123a and 123b are mechanically coupled to the back side of the movable mirror 110 for deforming or moving its front side flexible portion 110a which results in moving the inner bend resistant portion 110c in the image beam 130 direction relative to the second surface 115b of the top mirror 115.

As configured for FPTF device 100, the piezoelectric elements are biased to operate in pull mode, to provide displacement which acts to reduce the length of the gap 118 relative to the nominal length of the gap 118, such as at a rate determined by the piezoelectric coefficient (d)) of about 0.22 μm of displacement/10 V for PZT actuators. The piezoelectric coefficient d can be either positive or negative. To provide pull mode operation, the piezoelectric elements can be biased to become smaller in size in the direction of the image beam 130 which forces the back ring 120 shown in FIG. 1A to move to the left in FIG. 1A which due to contact with the back side flexible portion 110d acts to push the inner bend resistant portion 110c to the left and make the gap 118 smaller.

The piezoelectric actuators can be separate pieces as shown in FIG. 1A as piezoelectric elements 123a and 123b, and in FIG. 1B as piezoelectric elements 123a, 123b and 123c, or as a single ring structure, or as a single point actuator. Moreover, actuators other than piezoelectrics may also be used with disclosed embodiments such as disclosed in U.S. Pat. No. 6,915,048 to Kersey, including miniature (MEMs) versions of solenoids, pneumatic force actuators, or any other device capable of directly or indirectly applying an axial compressive force on the movable mirror 110. Further, a miniature stepper motor or other type of motor whose rotation or position can be controlled may be used to compress the movable mirror 110.

As described above, a spacer layer 119 having a desired protrusion length can be provided on outer bend resistant portion 110b by selectively defining a layer of a deposited material (e.g., silica) having a thickness equal to the desired protrusion length. Since in this embodiment the top mirror 115 is bonded to the protruding spacer layer 119 on the outer bend resistant portion 110b, the spacer layer 119 provides a nominal gap 118 with respect to the top mirror 115, such as a nominal gap 118 of 0.15 μm to 0.45 μm in some embodiments. The use of this type of structure allows relatively simple initial alignment of the complete FPTF and simple actuation with a single actuator or multiple actuators driven in synchronization without the need for complex sensing and control.

In another embodiment, the FPTF does not include a spacer layer 119 so that the inner bend resistant portion 110c and outer bend resistant portion 110b on the front side are the same thickness and are thus co-planar. The result is that when the top mirror 115 and movable mirror 110 are bonded together there is no nominal gap 118 in this embodiment, and the actuation control works in the pull mode to pull inner bend resistant portion 110c away from the top mirror 115 to provide a controllable gap. The pull mode can also include a spacer layer 119 so that the minimum gap 118 is non-zero.

As noted above, in an alternate embodiment the movable mirror 110 can comprise two thin (e.g., glass) flexible membranes supporting a central mirror (inner bend resistant portion 110c). In this embodiment the movable mirror 110 features inner bend resistant portion 110c as a central mirror supported by two thin (e.g., glass) flexible membranes, one membrane provided by thin front side flexible portion 110a near the cavity surface of the movable mirror 110 and another membrane provided by a separate plate providing flexible back side portion 110d on the back side surface of the movable mirror. This alternate arrangement also constrains the front side flexible portion 110a to move only in a highly linear (one-dimensional) motion. The FPTF 100 having the movable mirror 110 including the front side flexible portion 110a and inner bend resistant portion 110c solves problems experienced by broad bandwidth large area (10 mm) FPTFs which need precise parallelism (<0.02 arc seconds) between two very flat (<λ/200) mirror plates placed close together (e.g., 100-300 nm). Precise adjustment of the gap 118 between the top mirror 115 and the inner bend resistant portion 110c of movable mirror 110 is provided while maintaining precise parallelism.

FIG. 1D is a depiction providing various views of an example back ring 120. Back ring 120 provides an aperture 127 for the image beam 130 to pass to exit FPTF 100. The front side of the back ring 120 includes a protruding portion 124 and outside region 126. The back ring 120 mechanically connects the piezoelectric (e.g., PZT) elements 123a, 123b and 123c to the back side of the bend resistant portion 110c of the movable mirror 110 so that the expansion of the piezoelectrics in the direction of the image beam 130 results in the gap 118 being increased and contraction of the piezoelectrics in the direction of the image beam 130 resulting in the gap 118 being decreased. If the dimensions could be predetermined, the thickness of the piezoelectric elements 123a, 123b and 123c and the length of the protruding portion 124 would be the same. Since piezoelectric (e.g., PZT) elements are generally not consistent in size, an adhesive can be used to fill the extra gap.

The protruding portion 124 of the back ring 120 attaches to the back side of the movable mirror 110 across the holes 110f. The holes 100f themselves are machined out holes used to form the flexible back side portion 110d so that the back ring 120 does not actually attach to them but to the material left between the holes 110f. Piezoelectric elements 123a, 123b and 123c can be glued to the outside region 126 of back ring 120. The length of protruding portion 124 is set to match the thickness of the piezoelectric elements 123. Protruding portion 124 is thus configured and attached (e.g., bonded) to the back side of the movable mirror 110 to leave an aperture 127 for light to exit the AR coating on the inner bend resistant portion 110c on the back side of the movable mirror 110 (shown as AR coating 136 in FIG. 1C).

FIG. 1E shows another disclosed embodiment where the actuator 128 for moving the movable mirror 110 comprises an electro-magnetically driven solenoid 128a. The force produced by actuator 128 is proportional to the current supplied to the solenoid's coil (not shown). In the implementation shown, the actuator plunger 128b is mechanically connected to apply a force pushing onto the back surface of the inner bend resistant portion 110c of the movable mirror 110. A mechanical arm 128c is shown applying force at three points of this back surface in a push only configuration. The plunger 128b can be connected to the mechanical arm 128c with nuts, as shown, or glued or affixed in another matter that creates a solid connection for transmitting the force.

FIG. 1E also shows a plurality of protruding points 128d emanating from the mechanical arm 128c to apply the force. The center portion of the inner bend resistant portion 110c is unobstructed by the mechanical arm 128c as well as the protruding points 128d. Small adjustments in the positioning of these protruding points 128d with respect to the inner bend resistant portion 110c during assembly can be used to ensure that the force is applied evenly across the inner bend resistant portion 110c such that torque is minimized. The applied axial force to the inner bend resistant portion 110c will deform the front side flexible portion 110a as well as the back side flexible portion 110d and a displacement along the axis of the inner bend resistant portion 110c will result. This displacement depends linearly on the applied force, and the gap 118 of the FP is narrowed uniformly across the optical aperture.

In one example implementation, the tuning of the n=1 peak with force had a proportionality constant of 70 nm/N for a range of wavelengths covering the visible spectrum. The proportionality constant can be adjusted by choosing different thicknesses of the respective front side and back side flexible portions 110a and 110d and/or different distance between the inner bend resistant portion 110c and outer bend resistant portion 110b (such as by adding spacer layer 119 as described above). Portable devices which need low power consumption will use thinner and longer flexible portions to increase the proportionality constant, while a need for stability and immunity to vibration or acoustic noise will use a low proportionality constant.

Another embodiment comprises a FP device having built-in capacitive sensor(s). In this embodiment, two or more electrical capacitance gauges are used for in-situ measuring of the gap 118 and the parallelism of the FP filter plates (top mirror 115 and movable mirror 110). Although two capacitance gauges can be used, there are generally three or more gauges, such as three sets of capacitance gauges (e.g., 120 degrees apart), each gauge associated with a different actuator, such as a piezoelectric (e.g., PZT) actuator.

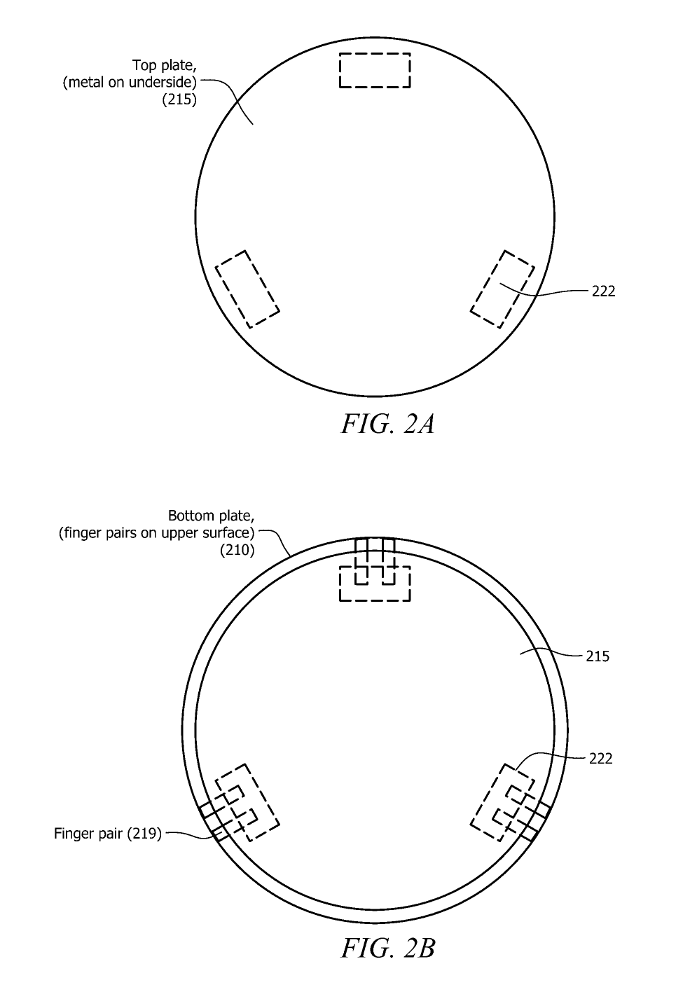

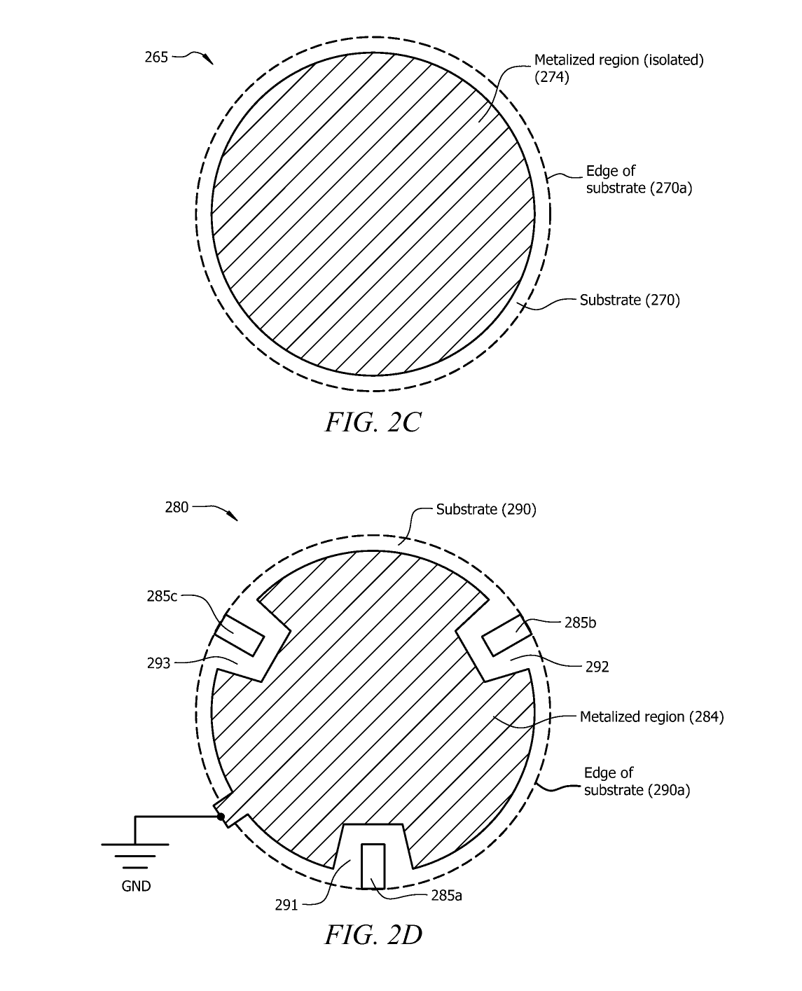

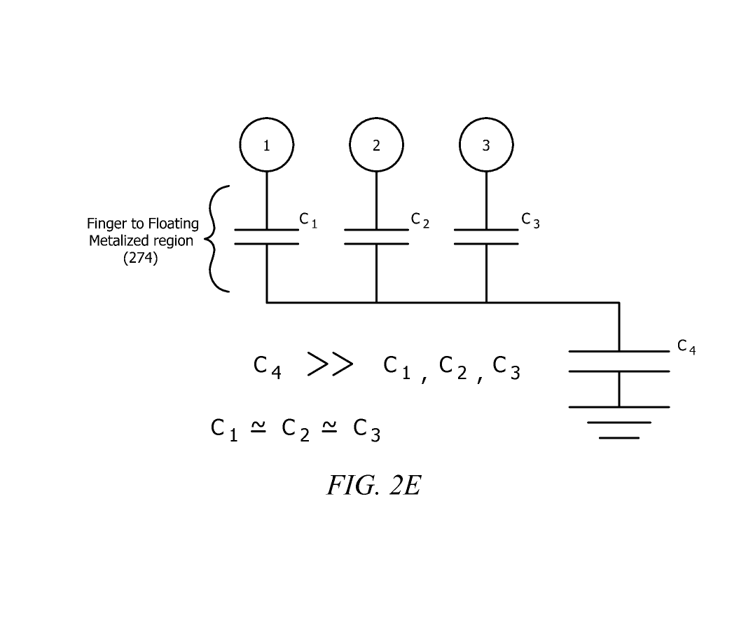

To reduce complexity of the FP device, one plate (the “base” plate) can be used for all the electrical connections, while only an isolated region of metallization (or other electrically conductive material) is used (one per finger pair) on the other upper electrically “floating” plate with no electrical connections to the upper plate (thus being an electrically floating electrode). The floating electrode bridges (is over) the two metal-coated regions on the lower base-plate in order that two air-spaced apart capacitors are formed in series, where the total capacitance between the finger pairs is based dependent on the spacing (d) between the base plate and the floating plate corresponding to gap 118. The capacitance between the fingers is negligible since the distance between the fingers in the finger pairs 219 is generally on the order of mms compared to the capacitance between the fingers and the floating electrode which is larger due to the distance (d) of the gap 118 between the plates (mirrors) being on the order of 1 μm (e.g., 0.15 μm to 0.45 μm). This is illustrated in the plate arrangement shown in FIGS. 2A and 2B.

FIG. 2A depicts an electroded top plate 215 (the floating plate) alone and FIG. 2B depicts the electroded top plate (or mirror) 215 proximate to the bottom plate (or mirror) 210 of an example FP device that provides a built-in capacitive sensor, according to an example embodiment. The metal patterns on top plate 215 can be on one of top mirror 115 or movable mirror 110 and the metal pattern on the bottom plate 210 can on the other of the top mirror 115 and movable mirror 110, both on the periphery of the plates (or mirrors) to be radially outside the image beam interaction region with FPTF. In operation, the image beam passes near the center of the plates (mirrors) 210/215 corresponding to inner bend resistant portion 110c described above where there are highly reflective surfaces on both ends of the FP cavity.

In FIG. 2A the electrically floating (isolated) patches of metal (or other electrically conductive layer) referred to as to electrodes 222 are provided (e.g., deposited) on the underside of the top plate 215, all generally having essentially the same size (area). As shown in FIG. 2B, on the bottom plate 210, finger pairs 219 are provided (e.g., deposited), shown as metalized areas/finger pairs 219, all generally having essentially the same size (area).

FIG. 2B shows the top electrodes 222 overlapping the finger pairs 219, where the spacing (d) between the two plates (top plate and bottom plate) determines the capacitance between each finger pair 219. The finger pairs 219 extend beyond the top plate 215 to allow electrical access thereto, such as to allow soldering. Although not shown, the finger pairs 219 can curl over the edge of the bottom plate 210. For an example 3 sensor arrangement, the parallelism of the FP plates (mirrors) can be controlled by monitoring the 3 values of d obtained at each of the sensors, for example by monitoring the frequency of 3 electronic oscillators in which the capacitances are the frequency-determining elements, and this signal can be used to control the force applied by a piezoelectric actuator, or other actuator associated with that sensor to maintain mirror parallelism.

FIGS. 2C and 2D depict electroded top and bottom mirrors of an example FP device providing a built-in capacitive sensor, while FIG. 2E provides the electrical equivalent circuit for the built-in capacitive sensor, according to another example embodiment. This embodiment is a simpler arrangement as compared to the arrangement described above by which the distance of the gap and the uniformity of the gap can be measured.

In FIG. 2C a top plate (or mirror) 265 is shown including a substrate 270 (e.g., fused silica for optical applications) with the outer edge of the substrate shown as 270a. The top plate (or mirror) 265 having the border shown is not necessary. A metalized region 274 is on the substrate 270 but does not extend to the outer edge of the substrate 270a. In operation, top plate (or mirror) 265 will be electrically floating and metalized region 274 will provide a single floating electrode. The central region will form the usable optical aperture of the FP filter.

In FIG. 2D a bottom plate (or mirror) 280 including a substrate 290 (e.g., fused silica for optical applications) with the outer edge of the substrate shown as 290a. Bottom plate (or mirror) 280 has a metalized region 284, the central region of which will form the usable optical aperture of the FP filter. In operation, the image beam passes near the center of the plates (mirrors) 270/290 corresponding to inner bend resistant portion 110c described above where there are highly reflective surfaces on both ends of the FP cavity, where metalized region 274 can provide one of those highly reflective surfaces.

Three regions 291, 292, and 293 spaced at 120 degrees are shown non-metalized, except for a single metalized “finger” 285a, 285b, 285c present on each other non-metalized region 291, 292, and 293 (substrate 290 itself), respectively, which can be optionally folded over the edge of the substrate 290a in order to facilitate electrical connections. Alternatively, the bottom plate (or mirror) 280 can simply be made larger than the top plate (or mirror) 265, so that the fingers 285a, b, and c can extend radially beyond the region covered by the top plate (or mirror) 265, again, to facilitate electrical connection. The metalized region 284 on the bottom plate (or mirror) 280 is shown electrically grounded as it will be during operation.

When the top plate (or mirror) 265 is placed over the bottom plate (or mirror) 280, the capacitance between the metalized region 284 on the bottom plate and the metalized region 274 on the top plate (or mirror) 265 (C₄ in the electrical equivalent figure shown in FIG. 2E described below) will be far greater than the capacitances between the fingers 285a, b, c and the metalized region 274 of the top plate (or mirror) 265 shown as C₁, C₂ and C₃ respectively in the electrical equivalent circuit shown in FIG. 2E.

Because the “sensor” capacitances C₁, C₂, C₃ are far smaller than C₄ (in the ratio of the areas of the fingers 285a, 285b, 285c as compared to the overlapping metalized region 274/284, they will dominate the sensitivity in total series capacitance to any changes in x1, x2, x3, where x1, x2 and x3 are the distances between the plates (or mirrors) 265 and 280 measured at fingers 285a, 285b, 285c, respectively. Measurement of the total series capacitance of C₁ and C₄ is possible between terminal (1) and ground, for example, and similarly for (C₂, C₄), (C₃, C₄) at terminals (2) and (3) respectively. These measurements can be used to monitor distances x1, x2, x3 and by using feedback to micropositioners (e.g., PZTs), to maintain parallelism and spacing of the top mirror 215 and movable mirror 210, explained in more detail below.

Regarding use of disclosed capacitive sensors to control mirror parallelism and thickness of the FP cavity, one example method control of the gap 118 is to employ 3 disclosed capacitive sensors at 120 degrees round the periphery of the FP cavity. The purpose of these capacitive sensors is to provide three independent distance measurements. The measurements can then be used to control the spacing and parallelism of the FP cavity by means of a look-up table and controller (e.g., processor-based) that outputs a voltage to each of the piezoelectric actuators in order to yield the gap 118 desired in order to tune to a given passband wavelength.

In one embodiment, each capacitor is used as the frequency-determining element in an electronic oscillator circuit. The measurement of the frequency of oscillation of each oscillator is can be used to determine the distance between the top mirror 115 and movable mirror 110 (=gap 118) at the location of that capacitor, by means of a previously compiled and stored look-up table. Assuming that all the capacitive sensors are of the same area, the parallelism condition will be achieved when all three oscillator frequencies are equal and no look-up table will then be needed. A feedback loop could be used during operation to make the mirrors maintain parallelism at all times by ensuring that at all times the voltages fed to the 3 piezoelectric s actuators caused the frequencies from the 3 respective oscillators to become equal.

Adding a constant bias voltage to each of the 3 voltages fed back to the piezoelectric actuators allows the gap thickness to be varied while simultaneously allowing the feedback loop to enforce the parallelism condition. The bias voltage used to determine the average gap thickness can be determined from a previously compiled look-up table. If the mirror parallelism condition is maintained, and the thicknesses measured at each sensor are the same, then the average gap thickness will be simply equal to the thickness of the gap 118.

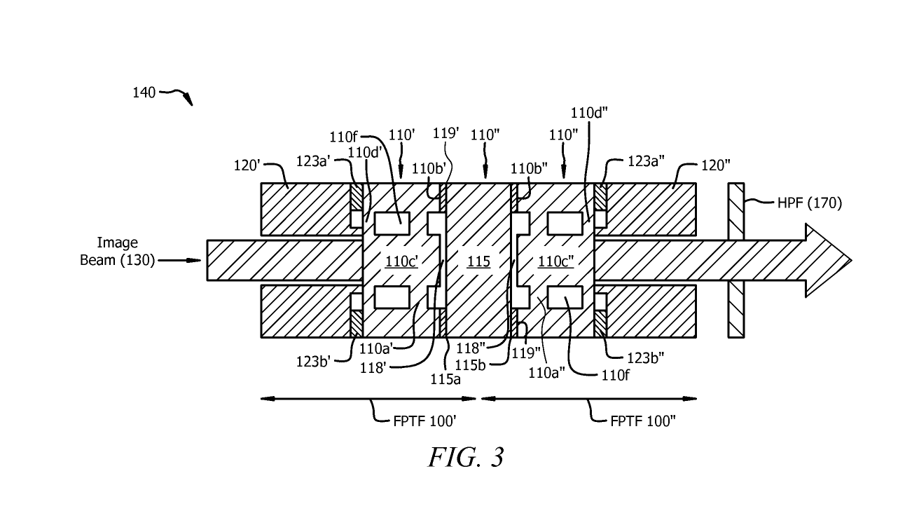

FIG. 3 is a cross-sectional depiction of an example multi-cavity Fabry-Perot filter shown as a dual-cavity FP filter 140 including a first FPTF 100′ and a second FPTF 100″ positioned back-to-back and sharing a top mirror 115 to provide tunable FP filters in series each having a disclosed movable mirror. An optional high pass filter (HPF) 170 is shown in series connection with the first FPTF 100′ and second FPTF 100″.

HPF 170 is useful for avoiding transmission peaks for short wavelengths outside the target tuning range of FP filter 140 (as for example shown in FIG. 4D for the peak ˜0.34 microns). A band pass filter (BPF) providing passing of the desired passband and desired blocking of short wavelengths outside the target tuning range may also be used. The combination of two FP filters with a HPF allows the dual-cavity FPTF to operate over a wavelength range larger than the free spectral range of either FPTF 100′ or FPTF 100″. In FIG. 3, all previously defined features for FPTF 100′ are given a ‘ suffix and all features for second FPTF 100″ and given a “suffix (e.g., front side flexible portion 110a’ for FPTF 100′). First FPTF 100′ and second FPTF 100” each include a spacer layer 119′ and 119″.

This embodiment recognizes improved FPTF optical performance can be obtained by using two (or more) FPTF's in series. However building and controlling FPTF devices having 2 gaps 118′, 118″ becomes significantly more complex as compared to building and controlling (e.g., tuning) an FPTF having a single gap 118, where tuning is facilitated by the FTFPs having disclosed movable mirrors. Embodiments including multiple FP filters in series solve the problem experienced by conventional single gap FPTFs which have limited optical performance in terms of a desired high ratio of maximum transmission on resonance versus minimum transmission of resonance. Single gap FPTF designs generally limit this ratio to ˜20%/0.2%=˜100:1. Disclosed dual gap FPTFs such as dual-cavity FP filter 140 can achieve a ratio of maximum transmission on resonance versus minimum transmission of resonance of ˜60%/0.06%=1000:1, this being about an order of magnitude (10×) better as compared to a single gap FPTF design.

The FPTF device having two or more FP filters in series can include different gaps for the respective filters. In this embodiment the respective FP filters each provide different free spectral ranges (FSRs) and the gaps are arranged so that overlap occurs between the transmission peaks of the lowest order (can call it n=1) of a first FP filter and a higher order peak (e.g., 2^{nd} or 3^{rd}, . . . ) of another (a second) FP filter. The higher order second FP has narrower transmission peaks but more peaks in a given wavelength band, so that this design ensures that its other peaks “miss” (i.e. do not overlap with) a transmission peak in the first FP filter. As shown in the data described below, this embodiment narrows the composite passband of the FP device while still retaining good out-of-band rejection. An advantage of this embodiment is that the composite peak resulting from the series combination of FP cavities is significantly narrower than would be obtained by having two identical FPTFs on the n=1 resonance in series, but retain the unambiguous 1 octave range. An issue for this embodiment can arise when working with a metal such as silver as the reflective surfaces in the visible light range because dispersion results in the blue end of the tuning range gets compressed making it difficult to keep spurious peaks out. However, by adding a suitable sharp cut-off HPF 170 with an edge near 450 nm to stop wavelengths <about 450 nm, the filter performance can be better than an identical pair of n=1 FP cavities in series in terms of overall passband width.

### Examples

Disclosed embodiments are further illustrated by the following specific Examples, which should not be construed as limiting the scope or content of this Disclosure in any way.

FIG. 4A-J show transmission spectrum data obtained from theoretical simulations for a dual-cavity FPTF device based on the dual-cavity FP filter 140 shown in FIG. 3. For the data in FIGS. 4A-4E (configured for visible light) the top mirror 115 and movable mirror 110 comprised fused silica. For the data in FIGS. 4F-4J (configured for infrared light) the top mirror 115 and movable mirror 110 both comprised calcium fluoride (CaF₂). Optical surfaces were assumed to be flat.

FIG. 4A through 4E all refer to dual-cavity FP filter 140 configured for a visible light application by tuning the filter design to a nominal wavelength of 0.55 microns by setting the appropriate distance for gap 118. FIG. 4A shows the transmission spectrum 401 (first order) of a n=1 FP filter with a gap 118 of 0.17 microns and the transmission spectrum 402 (second order) of an n=2 FP filter with a gap 118 of 0.45 microns. The peak near 0.55 microns can be seen to be common to both FP filters. The index data is only accurate to just over 1.1 microns, so the small extra peak near 1.2 μm should be ignored.

FIG. 4B shows the transmission spectrum of a double pass through n=1 FP filters where operation is assumed only in first order, and only the wavelength range above 0.4 microns is shown. The transmission spectrum shown in FIG. 4B is equal to the square of transmission spectrum 401 shown in FIG. 4A.

FIG. 4C shows the transmission spectrum of a pass through n=1 FP filter and an n=2 FP filter in series. The transmission spectrum is equal to the transmission spectrum 401×(multiplied by) transmission spectrum 402 both shown in FIG. 4A. The narrowing of the passband can be seen compared to the double pass through n=1 FP filters shown above in FIG. 4B. It can be seen from FIGS. 4B and 4C that the concatenation of the two different FP filters produced a narrower composite response, with the FWHM line-width reduced by ˜30%. This concept can be taken further with additional series connected FP filters, but more spurious peaks at the short wavelength end may appear (e.g., n=3) that can cause problems with out of band light.

FIG. 4D shows the transmission spectrum of a pass through n=1 (shown as 401) and n=3 FP filter (shown as 415) in series. The transmission spectrum shows an extra peak at the short wavelength end. FIG. 4D is the exact equivalent of FIG. 4A but n=3 instead of n=2 is shown along with n=1. FIG. 4E shows the transmission spectrum of a pass through n=1 and n=3 FP filters. The transmission spectrum is equal to the transmission spectrum 401×transmission spectrum 415 shown in FIG. 4D. The short wavelength transmission shown as 401 and 415 below 0.4 microns can be suppressed by a HPF. For a device operating at longer wavelengths with 0.5 microns of Te used as the FP coating 129, performance can be improved because mirror coatings do not have large dispersion in the tuning range (at the blue end in the previous example). Ge can also be used as the FP coating 129, but will produce different results.

FIG. 4F shows the transmission spectrum of a pass through n=1 FP filter (3.9 micron gap) shown as 417 and n=3 (12 micron gap) FP filter shown as 418 superimposed for a dual cavity FP filter configured for a mid-infrared range application by tuning the filter design to a nominal wavelength of about 8 microns by setting the appropriate distance for gaps 118. Note peaks from both FPTFs shown at about 8 microns. The transmission curves are those of individual filters, not the assembly. As noted above, the top mirror 115 and movable mirror 110 were made of CaF₂. The FP coating 129 comprises 0.5 microns of Te.

FIG. 4G shows the transmission spectrum of a pass through two n=1 (3.9 micron) FP filters in series. The transmission spectrum in FIG. 4G is equal to the square of transmission spectrum 417 shown in FIG. 4F.

FIG. 4H shows the transmission spectrum of a n=1 (3.9 micron) FP filter in series with a n=3 (12 micron) FP filter. As in the visible light examples, the curve in FIG. 4G assumes two filters tuned equally to n=1 transmission, so the transmission is the square of transmission spectrum curve 417 shown in FIG. 4F. FIG. 4H is an assembly having the two FP filters tuned to n=1 and n=3 respectively. This assembly's transmission spectrum then is the product of transmission spectrum curves 417 and 418. In FIG. 4H it can be seen the peak near 8 microns is approaching 50% the width of the peak in FIG. 4G. At the other end of the tuning range (12 microns), the corresponding results are given in FIG. 4I and FIG. 4J described below.

FIG. 4I shows the transmission spectrum of two n=1 (6.185 micron gap) FP filters in series, tuned to 12 microns Tuning as used herein refers to the actuator (e.g., PZT actuators) used to change to the distance of the gap 118 such that the transmission peak for the desired order (n) occurs at the wavelength to which it is tuned. So the input is order and wavelength, and the distance of the gap 118 is adjusted accordingly. FPTF instruments will specify the wavelength, and the two FP filters can adjust their gaps 118 to center their desired transmission peaks at that wavelength.

FIG. 4J shows the transmission spectrum of a n=1 (6.185 micron) FP filter in series with a n=3 (18.15 micron) FP filter. As evidenced again, the use of n=1 and the n=3 FP filters in series gives a narrower composite transfer function than two n=1 FP devices, and using suitable high pass filters to stop out-of-band light, low levels of spurious peaks in the 8 to 12 μm window are achieved. It is noted that the peak transmission is very good because unlike the case of silver films, the refractive indices of the Ge and tellurium (Te) film FP coatings (mirror surfaces) have very small imaginary parts in this spectral region.

Applications for disclosed FPTF devices include both imaging and non-imaging systems. Non-imaging systems include, for example, spectrometers and tunable laser filters.

Those skilled in the art to which this disclosure relates will appreciate that many other embodiments and variations of embodiments are possible within the scope of the claimed invention, and further additions, deletions, substitutions and modifications may be made to the described embodiments without departing from the scope of this disclosure.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A Fabry-Perot tunable filter (FPTF), comprising:
a top mirror having a first surface for receiving a light beam and a second surface opposite said first surface;
a movable mirror having a front side secured to said second surface of said top mirror and a back side, said movable mirror including:
an inner bend resistant portion;
said front side including a flexible front side portion outside said inner bend resistant portion recessed relative to said inner bend resistant portion, and a front side outer bend resistant portion thicker than said flexible front side portion outside said flexible front side portion,
said back side including a flexible back side portion outside said inner bend resistant portion and a back side outer bend resistant portion thicker than said flexible back side portion outside said flexible back side portion, and
an actuator mechanically coupled to said back side of said movable mirror for deforming or moving said inner bend resistant portion relative to said second surface of said top mirror.

2. The FPTF of claim 1, wherein said outer bend resistant portion on said front side further comprises a spacer layer which protrudes toward said second surface of said top mirror relative to said inner bend resistant portion to provide a nominal gap between said inner bend resistant portion and said second surface of said top mirror.

3. The FPTF of claim 2, wherein said spacer layer comprises a same chemical composition as a material for said movable mirror.

4. The FPTF of claim 3, wherein said spacer layer comprises amorphous silicon dioxide and said material for said movable mirror and said top mirror both comprise fused silica.

5. The FPTF of claim 1, wherein said actuator comprises at least one piezoelectric element and an associated electrode electrically coupled to said piezoelectric element, wherein said piezoelectric element operates in pull mode for pushing said inner bend resistant portion toward said second surface of said top mirror.

6. The FPTF of claim 1, wherein said actuator comprises an electro-magnetically driven force actuator for pushing said inner bend resistant portion toward said second surface of said top mirror.

7. The FPTF of claim 6, wherein said electro-magnetically driven force actuator includes a plunger connected to a mechanical arm which is connected to a plurality of contact points that are coupled to each apply force to different locations on said back side outer bend resistant portion.

8. The FPTF of claim 1, wherein said inner bend resistant portion is three (3) to twenty (20) times thicker as compared to a thickness of said flexible front side portion and said flexible back side portion.

9. The FPTF of claim 1, wherein said FPTF comprises a multi-cavity Fabry-Perot filter including a first said FPTF (first FPTF) and a second said FPTF (second FPTF) positioned back-to-back and sharing said top mirror,
wherein said first FPTF provides a first nominal gap; and
wherein said second FPTF provides a second nominal gap, and
wherein said first nominal gap and said second nominal gap are selected so that overlap occurs between a transmission peak of said first FPTF and a transmission peak of said second FPTF.

10. The FPTF of claim 9, wherein a lowest order transmission peak of said first FPTF overlaps with a higher order transmission peak of said second FPTF.

11. The FPTF of claim 9, further comprising a high pass filter in series connection with said first FPTF and said second FPTF.

12. The FPTF of claim 9, wherein said top mirror and said movable mirror comprise calcium fluoride (CaF₂) or a chalcogenide substrate.

13. The FPTF of claim 1, further comprising an in situ capacitive sensor, said capacitive sensor comprising:
said top mirror or said movable mirror having a first side including at least two metalized areas thereon positioned outside an inner portion of said top mirror or said movable mirror that is in a path with said light beam, said metalized areas each including two or more spaced apart metal features having structure for electrically connecting thereto,
the other of said top mirror and said movable mirror having unconnected regions of metallization or other electrically conductive material thereon to providing floating electrodes facing and at least partially overlapping said metalized areas to provide two air-spaced apart capacitors in series for each overlap.

14. The FPTF of claim 13, wherein said spaced apart metal features are configured as metal fingers positioned parallel to one another or metal regions connected to said metal fingers which run to a periphery of said top mirror or said movable mirror to facilitate electrical connection thereto.

15. The FPTF of claim 1, further comprising an in situ capacitive sensor, said capacitive sensor comprising:
said top mirror or said movable mirror having a first side including a single metalized region positioned that is in a path with said light beam,
the other of said top mirror and said movable mirror having a metalized region and a plurality non-metalized regions each including a single electrically isolated metal finger to providing floating electrodes facing and at least partially overlapping said single metalized region.
